(19) United States
(12) Patent Application Publication
(10) Pub. No.: US 2017/0282306 A1
(43) Pub. Date: Oct. 5, 2017

(54) Aluminium Solder Alloy Free from Si Primary Particles and Method for Producing It

(71) Applicants: Hartmut Janssen, Hilden (DE); Katrin Kuhnke, Solingen (DE); Werner Droste, Bonn (DE); Gerd-Ulrich Grün, Troisdorf (DE)

(72) Inventors: Hartmut Janssen, Hilden (DE); Katrin Kuhnke, Solingen (DE); Werner Droste, Bonn (DE); Gerd-Ulrich Grün, Troisdorf (DE)

(73) Assignee: Hydro Aluminium Rolled Products GmbH, Grevenbroich (DE)

(21) Appl. No.: 15/623,050

(22) Filed: Jun. 14, 2017

Related U.S. Application Data
(63) Continuation of application No. PCT/EP2015/079399, filed on Dec. 11, 2015.

(30) Foreign Application Priority Data
Dec. 23, 2014 (EP) 14199939.1

(51) Int. Cl. B23K 35/28; C22C 1/02; B21B 3/00; B22D 7/00; B23K 35/02; C22C 21/02; B32B 15/01

(52) U.S. Cl. CPC B23K 35/286; C22C 21/02; C22C 1/026; B32B 15/016; B22D 7/005; B23K 35/0238; B21B 3/00; B21B 2003/001

(57) ABSTRACT

The invention relates to an ingot consisting of an aluminium solder alloy having in percentage by weight 4.5%≦Si≦12%; and optionally one or more of the following alloying constituents in percentage by weight: Ti≦0.2%, Fe≦0.8%, Cu≦0.3%, Mn≦0.10%, Mg≦2.0%, Zn_23 0.20%, Cr≦0.05%, with the remainder aluminium and unavoidable impurities, individually at most 0.05 wt %, in total at most 0.15 wt %, wherein boron is additionally provided as an alloying constituent, wherein the boron content is at least 100 ppm and the aluminium alloy is free from primary Si particles having a size of more than 20 μm. The invention further relates to an aluminium alloy product consisting of an aluminium alloy, to an ingot consisting of an aluminium alloy and to a method for producing an aluminium alloy.

### CROSS-REFERENCE TO RELATED PATENT APPLICATIONS

This patent application is a continuation of PCT/EP2015/079399, filed Dec. 11, 2015, which claims priority to European Application No. 14199939.1, filed Dec. 23, 2014, the entire teachings and disclosure of which are incorporated herein by reference thereto.

### FIELD OF THE INVENTION

The invention relates to an ingot consisting of an aluminium solder alloy having the following proportions as alloying constituents in percentage by weight:

4.5%≦Si≦12%

and optionally one or more of the following proportions as alloying constituents in percentage by weight:

Ti≦0.2%,

Fe≦0.8%,

Cu≦0.3%,

Mn≦0.10%,

Mg≦2.0%,

Zn≦0.20%,

Cr≦0.05%,

with the remainder aluminium and unavoidable impurities, individually at most 0.05 wt %, in total at most 0.15 wt %. Inter alia, dependent on the soldering method used, the Mg content of the aluminium solder alloy of the invention is optionally 1.0 wt % to 2.0 wt %, at most 0.4 wt %, preferably at most 0.2 wt % or at most 0.1 wt % The aluminium solder alloy can also be essentially free of Mg, i.e. Mg only contained in traces, and have an Mg content of less than 100 ppm or less than 50 ppm. The invention further relates to an aluminium alloy product at least partially consisting of an aluminium solder alloy and to a method for producing an aluminium solder alloy.

### BACKGROUND OF THE INVENTION

Aluminium solder alloys having Si contents of 4.5 wt % to 12 wt %, so-called hypoeutectic aluminium-silicon alloys, are especially used for the soldering of components, preferably aluminium components, due to the relatively low melting point. The aluminium solder consisting of an AlSi aluminium alloy can, for example, be provided in the form of soldering foils, but also by a composite material which has an AlSi aluminium alloy layer. In particular, if a number of soldering points are to be soldered and the components have a complex shape, which heat exchangers for example have, strips, sheets or semi-finished products comprising an AlSi aluminium alloy layer are often used. Heat exchangers of motor vehicles are often soldered using an aluminium solder. The solder layers are generally very thinly formed, on the one hand, in order to save material and, on the other hand, so as not to negatively affect the properties of the core material present in the composite material. Increased demands are being placed on the microstructure of the solder layers due to the increasing reduction in the thickness of the solder layers and of the core material.

From the field of dead-mould casting, it is known, for example, to incorporate improving elements such as strontium and sodium, or refining elements, such as antimony, into the alloy, in order to influence the eutectic microstructure or the eutectic microstructure proportions. However, these improving or refining alloy elements are not considered for use in aluminium solders, since they can interfere with the soldering process and impede recycling. In conventional production of AlSi aluminium alloys, firstly a primary aluminium pig is melted together with silicon in a melting or casting furnace and other alloying elements are added to the alloy. In dead-mould casting, it is known, for example, to add master alloys consisting of AIB in casting alloys containing Si for grain refinement of the primary alpha-aluminium phase.

Unlike in the field of dead-mould casting, ingots are produced by casting, in particular by DC casting, in order to process these further into strips or sheets, for example by rolling or sawing. Therefore, after producing the ingot, the ingot material usually passes through a further massive forming step, for example in a subsequent rolling operation. This is not provided for in the field of dead-mould casting, since in the field of dead-mould casting, parts similar to the final shape are usually cast.

Aluminium solder alloys are usually processed further into rolled ingots and sheets subsequently produced from them clad onto other rolled ingots. However, sawing out cladding sheets from the ingots and roll cladding together with a core ingot is also conceivable here. In the field of rolled ingots, aluminium titanium boride (AlTiB) master alloys, for example AlTiB wires, are usually used for grain refinement and fed to the alloy in the molten state. The boron contents are typically in the range from 5 to 30 ppm.

A microstructure results from this which for the AlSi aluminium alloy up to now has been sufficient for use as a solder layer. However, it has become apparent that, on the one hand, the soldering procedure could not be carried out with sufficient process reliability in the case of extremely thin aluminium solder layers. On the other hand, partial melting and erosion or holes in the components occurred after soldering. Components with thin walls are particularly affected by this.

It has been found that primary silicon particles are not only present in small amounts in hypereutectic Al—Si alloys, but also in hypoeutectic Al—Si alloys. Primary Si particles are particles which consist of pure silicon and are present in crystalline form in conventional aluminium alloys. It has become evident that the soldering problems in particular are caused by primary Si particles, particularly when, depending on the application, they have a size of more than 20 or 10 μm. However, during the soldering process, primary Si particles result in a local surplus of Si in the solder layer, whereby the core material is also locally fused in the vicinity of the primary Si particles. This then leads to erosion (“burning through”) or formation of a hole in the product coated with an aluminium solder layer during soldering.

This problem is, for example, described in the European patent application 2 479 296 A1 which relates to generic aluminium alloys. It is proposed there that the phosphorus and boron contents of the aluminium-silicon alloy are each limited to 10 ppm. It has been shown that primary Si particles having a size of more than 10 μm can thereby be prevented. As a result, the soldering procedure can be carried out in a process-reliable way and local fusing of the aluminium alloy core material does not occur.

However, the disadvantage of this approach is that the aluminium starting material is subject to relatively strict restrictions with regard to the accompanying elements, such as phosphorus and boron, during production. As a result, one is faced with a production process which is comparably cost-intensive.

Alternatively, it is also possible to use particularly pure starting materials for aluminium and silicon, in order to reduce or prevent the occurrence of primary Si particles. Due to the high costs involved in providing such pure materials, however, this alternative also represents a comparatively complicated and expensive solution.

### BRIEF SUMMARY OF THE INVENTION

On this basis, the object of the present invention is to provide an ingot consisting of an AlSi aluminium solder alloy for producing aluminium alloy products which enables aluminium alloy products to be produced for an improved soldering process and, at the same time, allows production to be carried out in a cost-effective way. In addition, the it is an object of the present invention to propose an aluminium alloy product and a method for producing an ingot consisting of the aluminium solder alloy.

According to a first teaching of the present invention, the disclosed object is achieved by a generic aluminium alloy, wherein boron is additionally provided as an alloying constituent, wherein boron is added to the alloy added to the alloy such that the boron content is at least 100 ppm and the aluminium alloy is free from primary Si particles having a size of more than 20 μm, in particular 10 μm.

The inventors have recognised that it is possible to prevent the occurrence of primary Si particles having a size of more than 20 μm by means of an increased boron content of at least 100 ppm compared to the boron content of 5 to 30 ppm in conventional alloys. The boron is added to the alloy such that the aluminium alloy is free from primary Si particles having a size of more than 20 μm, in particular 10 μm. This new approach therefore deviates from the approach followed up to now in the prior art of limiting the boron content. Instead, the boron content is increased such that the aluminium alloy has a considerably finer grain structure and is free from Si particles having a size of more than 20 μm. Setting the specific boron content can in specific cases for example depend on other alloying constituents.

At the same time, by adding boron with minimum contents of 100 ppm, on the one hand, a grain-refining effect of the alpha-aluminium is achieved and, on the other hand, the eutectic Si phases are also considerably more finely formed than in the prior art.

As a result, a soldering procedure can be carried out in a more process-reliable way and a solder connection can be provided in a process-reliable way, since local fusing of the aluminium alloy core material does not occur. This particularly applies to aluminium solder layers and aluminium alloy core materials which are particularly thinly formed, for example which are in the range from 15 μm to 30 μm for the solder layer and from 50 μm to 120 μm for the core material, since the effect of hole formation due to primary Si particles present having a size of more than 20 μm increasingly occurs with these layer thicknesses.

On the other hand, however, the aluminium alloy according to the invention can be produced in a particularly cost-effective way compared to previous aluminium alloys. No ultra-pure components have to be used. For example, one can start from aluminium 99.85 combined with metallurgical silicon, since the production process is subject to considerably fewer restrictions by the accompanying elements of the aluminium starting material. It has been shown that the reduction in costs can amount to a factor of up to 10.

With regard to applications in which the result is already negatively affected by small amounts of Si particles, according to a preferred embodiment, the aluminium solder alloy according to the invention no longer has any primary Si particles at all. In this way, a result which is particularly more process-reliable is obtained using the aluminium solder alloy. Preferably, the aluminium solder alloy has a phosphorus content of at most 30 ppm, of at most 20 ppm or of at most 10 ppm. It has been shown that the formation of primary Si particles having a size of more than 20 μm or more than 10 μm can be suppressed by this means in an even more process-reliable way.

Preferably, the aluminium solder alloy, except for the non-existent primary Si particles having a size of more than 20 μm, corresponds to one of the alloy specifications of the type AA 4043, AA 4343, AA 4045, AA 4044 or AA 4104. The specific alloy types are in combination with different aluminium alloys used as aluminium solders in quite specific application areas.

The aluminium alloy type AA 4043 for example has an Si content 4.5 to 6.0 wt %, an Fe content of at most 0.8 wt %, a Cu content of at most 0.30 wt %, an Mn content of at most 0.05 wt %, an Mg content of at most 0.1 wt %, a Zn content of at most 0.10 wt %, and a Ti content of at most 0.20 wt % Typical applications of the alloy AA 4043 are its utilization as an aluminium solder preferably in combination with fluxes.

The Mg-free aluminium alloy type AA 4343 for example has an Si content of 6.8 to 8.2 wt %, an Fe content of at most 0.8 wt %, a Cu content of at most 0.25 wt %, an Mn content of at most 0.10 wt % and a Zn content of at most 0.20 wt % The aluminium alloy type AA 4343 is preferably used in combination with or without fluxes for soldering in a protective gas atmosphere or in the CAB process (Controlled Atmosphere Brazing).

The aluminium alloy type AA 4045 exhibiting a higher Si content contains 9.0 to 11.0 wt % Si, at most 0.8 wt % Fe, at most 0.30 wt % Cu, at most 0.05 wt % Mn, at most 0.05 wt % Mg, at most 0.10 wt % Zn and at most 0.20 wt % Ti. This aluminium alloy is also preferably used in combination with or without fluxes for soldering in a protective gas atmosphere or in the CAB process.

The Mg-free aluminium alloy type AA 4044 contains 7.8 to 9.2 wt % Si, at most 0.8 wt % Fe, at most 0.25 wt % Cu, at most 0.10 wt % Mn and at most 0.20 wt % Zn. It is also used for the CAB soldering process.

Finally, the aluminium alloy type AA 4104 contains 9.0 to 10.5 wt % Si, at most 0.8 wt % Fe, at most 0.25 wt % Cu, at most 0.1 wt % Mn, 1.0 to 2.0 wt % Mg and at most 0.05 wt % Zn, 0.02 to 0.20 wt % Bi. This alloy type is preferably used as solder in vacuum brazing.

All five alloy types contain impurities in individual contents of at most 0.05 wt % and in total at most 0.15 wt % The mentioned aluminium solder alloys are particularly suitable for use as solder layers in combination with different alloy types. All alloys have in common the fact that in conventional production they exhibit primary Si particles, whereas the aluminium solder alloys according to the invention are free from primary Si particles having a size of more than 20 μm, in particular 10 μm, due to the boron content of at least 100 ppm. Furthermore, the aluminium alloy according to the invention is, preferably, completely free from primary Si particles, so that particularly thin aluminium solder layers can be provided for with the aluminium alloy according to the invention which provide process-reliable solder connections.

According to a first embodiment of the aluminium solder alloy according to the invention, the aluminium alloy has a Si content of 6%≦Si≦11%. It has been found that the use of the invention in the area of the alloy specifications of the type AA 4343, AA 4045, AA 4044 or AA 4104 is particularly advantageous.

According to another embodiment of the aluminium alloy according to the invention, primary Si particles above a certain size can be particularly reliably prevented by the boron content being ≧140 ppm, preferably ≧220 ppm, and/or ≦1000 ppm, preferably 800 ppm. It has been found that the boron content can be set especially within these ranges to a content such that the aluminium alloy is free from primary Si particles having a size of more than 20 μm and, as a result, the formation of primary Si particles in the aluminium alloy can be even better suppressed. At the same time, a grain-refining effect of the alpha-aluminium is achieved, whereby the addition of further grain refiners is omitted. This effect has materialized starting from a boron amount of 140 ppm or at more than 220 ppm. Preferably, the boron content is therefore at least 250 ppm, in particular at least 300 ppm has proved advantageous.

A particularly reliable way of determining the required boron content for preventing primary Si particles has proved itself if, according to another embodiment of the aluminium alloy according to the invention, boron is added to the alloy dependent on one or more other alloying constituents. Due to the interaction of the alloying constituents between one another, it has become apparent that the formation of primary Si particles can be particularly reliably suppressed if the boron content is determined or added to the alloy dependent on one or more other alloying constituents.

According to a particularly advantageous embodiment of the aluminium alloy according to the invention, it has been found that primary Si particles can be optimally suppressed if boron is added to the alloy dependent on the Ti, Zr and/or V contents, in particular in such a way that the boron content corresponds to at least one times, to at least one and a half times, to at least two and a half times or to at least three times the amount of the sum of the Ti, Zr and V and Cr contents. This dependence can be used to reliably set the boron content to a value of at least 100 ppm in the rolled ingot. Thus, for example, an additional amount of boron can be determined for the addition of boron to the melt dependent on the Ti, Zr, V and Cr contents of the initial melt, in order to take into account the formation of borides with the known alloying constituents and their deposition in the furnace. The effect of the grain refinement and the prevention of Si primary particles can in this way be effectively ensured. The boron content can then preferably be set to at least 100 ppm, 140 ppm, 220 ppm and/or at most 1000 ppm or 800 ppm.

It also follows from this that it is advantageous if the sum of Ti, Zr, V and Cr contents is at most 500 ppm, in particular at most 400 ppm and/or at least 50 ppm, in particular at least 100 ppm. The contents of Ti, Zr or V are preferably at most 400 ppm, particularly preferably at most 300 ppm, in order to reduce negative effects on the castability of the alloy, the rollability of the ingot or in the case of Zr the recyclability.

According to a second teaching of the present invention, the aforementioned object is achieved by an aluminium alloy product at least partially consisting of an aluminium solder alloy according to the invention. Corresponding aluminium alloy products can have extremely thin solder layers and can still be soldered very well.

The aluminium alloy products can be provided particularly easily by the aluminium alloy product being in the form of a strip and having at least one further layer consisting of aluminium or of another aluminium alloy. The strip-shaped aluminium alloy product can have a very thin aluminium solder layer consisting of the aluminium alloy according to the invention and still possess very good soldering properties. The strip can easily be separated into a plurality of sheets which are then subjected to further production steps in order to produce solderable semi-finished products or finished components.

Preferably, the strip is produced by roll cladding or composite casting. Both aluminium alloy layers are materially bonded to one another at their boundary surfaces. Both methods can be used economically for producing aluminium composite materials which have a layer consisting of an aluminium alloy according to the invention as an aluminium solder layer.

Since a solder connection can be provided which can be produced in a way which is particularly process-reliable using the aluminium alloy according to the invention, it is advantageous if the aluminium alloy product is formed as part of a soldered component, in particular of a heat exchanger. As already previously explained, solder connections are an important part of different components, in particular in heat exchangers of motor vehicles. The aluminium alloy product according to the invention is especially suitable for providing solder connections which are process-reliable.

According to a third teaching of the present invention, the previously established object is also achieved by an ingot consisting of an aluminium alloy according to the invention for producing an aluminium alloy product according to the invention. As a result of utilizing an aluminium alloy according to the invention, the milled ingot no longer has any primary Si particles with a size of more than 20 μm.

Ingots are usually used for producing aluminium alloy products by rolling the ingot. However, the ingot can also be used for producing cladding sheets by sawing shells out of the ingot.

The number of primary Si particles is determined on a slice of the milled ingot, which is cut out perpendicularly with respect to the casting direction, in each case on the surface in the middle of the ingot at a depth of one quarter of the thickness of the ingot and in the centre of the ingot over an area of at least 600 mm². The ingot according to the invention is therefore particularly suitable for being further processed into a cladding sheet or into a soldering foil. The cladding sheets can be sawed out of the ingot or by rolling the ingot. The cladding sheet is usually applied to the core material or core ingot and is correspondingly roll-clad, in order to provide a solderable aluminium composite material. As a result, the ingot according to the invention can be used to produce aluminium alloy products which can be soldered particularly well.

Preferably, the ingot according to the invention is free from primary Si particles having a size of more than 10 μm. Furthermore, the ingot according to the invention is preferably free from primary Si particles, i.e. in a slice separated from the milled ingot perpendicularly with respect to the casting direction of the ingot, no primary Si particles can be detected in the middle of this slice in areas of at least 600 mm² on the surface, at a height of one quarter of the ingot thickness and in the centre of the ingot. The primary Si particles are counted within the corresponding area on polished sections under a microscope.

As already explained, ingots according to the invention do not have any primary Si particles with a size of more than 20 μm, in particular 10 μm, and preferably do not have any primary Si particles at all. The ingots according to the invention thereby clearly differ from conventionally produced ingots for producing aluminium alloy products with an increased boron content.

According to a fourth teaching of the present invention, the above disclosed object is achieved by providing a method for producing an aluminium alloy according to the invention, in which
pure aluminium with unavoidable impurities, individually at most 0.05 wt %, in total at most 0.15 wt %, is melted in a melting furnace,
optionally one or more of the following proportions

Ti≦0.2%,

Fe≦0.8%,

Cu≦0.3%,

Mn≦0.10%,

Mg≦2.0%,

Zn≦0.20%,

Cr≦0.05%,
are added to the alloy as further alloying constituents in percentage by weight in the melting furnace or are already at least partially contained in the pure aluminium,
silicon is added to the alloy in the melting furnace until an Si content of 4.5 wt % to 12 wt % of the aluminium alloy has been reached, and
wherein boron is added to the alloy such that the boron content is at least 100 ppm and the solidified aluminium alloy is free from primary Si particles having a size of more than 20 μm, in particular 10 μm.

It has been found that the formation of primary Si particles can not only be suppressed by highly restrictively limiting the accompanying elements, but also with significantly higher boron contents than is usual. Formation of primary Si particles having a size of more than 20 μm, in particular 10 μm, can thereby be prevented without a costly restriction of the accompanying elements. In the method according to the invention, the boron content is set to at least 100 ppm, so that the solidified aluminium alloy is free from primary Si particles having a size of more than 20 μm, in particular 10 μm.

According to one embodiment of the method according to the invention, particularly advantageously the addition of further grain refiners, in particular grain refiners having titanium borides, can be omitted. A grain-refining effect on the alpha-aluminium is already obtained as a result of the addition of boron, whereby the addition of other grain refiners, such as AlTiB wire, can be omitted. As already mentioned, the eutectic Si phases are also formed considerably more finely.

In one preferred embodiment of the method according to the invention, the B content is set to 140 ppm, preferably 220 ppm, and/or 1000 ppm, preferably 800 ppm. As already explained, a further increase in the process reliability in producing aluminium alloys free from primary Si particles is thereby obtained, since the boron content in the cast rolled ingot can be reliably set such that a further reduction in the size of the primary Si particles as well as an aluminium alloy which is completely free from primary Si particles can be provided.

As has also already been explained with regard to the aluminium alloy, according to one embodiment of the method according to the invention, boron is preferably added to the alloy dependent on one or more other alloying constituents. It has been recognised as particularly advantageous for suppressing the primary Si particles in an optimum way if the boron is added to the alloy dependent on the Ti, Zr, V and Cr contents, in particular in such a way that the boron content corresponds to at least one times, to one and a half times, to two and a half times or to at least three times the amount of the sum of the Ti, Zr, V and Cr contents of the starting melt. Preferably, the ratio of the boron content to the sum of the contents of Ti, Zr, V and Cr can be at least 5 or at least 10.

As explained above, it is advantageous if the sum of the Ti, Zr, V and Cr contents is at most 500 ppm, in particular at most 400 ppm, and/or at least 50 ppm, in particular at least 100 ppm. The contents of Ti, Zr or V are preferably at most 400 ppm, particularly preferably at most 300 ppm.

If, according to another embodiment of the method according to the invention an aluminium alloy type AA4xxx, in particular type AA 4043, AA 4343, AA 4045, AA 4044 or AA4104 is produced, the properties of the aluminium alloy produced by means of the method can be utilised in an optimum way, so that an improved soldering process can be ensured both with CAB soldering and with vacuum soldering.

As has also been previously explained, it is advantageous if the aluminium solder alloy used in the method has a phosphorus content of at most 30 ppm, at most 20 ppm or at most 10 ppm.

For further embodiments of the method according to the invention, of the ingot according to the invention and of the aluminium alloy product according to the invention, reference is made to the statements regarding the advantageous embodiments of the aluminium alloy according to the invention.

### BRIEF DESCRIPTION OF THE SEVERAL VIEWS OF THE DRAWING

The invention is explained in more detail below on the basis of an exemplary embodiment and in conjunction with the figures.

In the drawings,

FIG. 1 shows in a sectional view a milled cast ingot with marked areas for determining the number of primary Si particles,

FIG. 2 is a micrograph of a comparison aluminium solder alloy having coarse primary Si particles of 20 μm or larger,

FIGS. 2a and 2b are micrographs of a comparison aluminium solder alloy at different magnifications,

FIGS. 3a and 3b are micrographs of an inventive aluminium solder alloy at different magnifications, according to an exemplary embodiment of the present invention,

FIGS. 4a and 4b are micrographs of a comparison aluminium solder alloy at different magnifications,

FIGS. 5a and 5b are micrographs of an inventive aluminium solder alloy at different magnifications, according to an exemplary embodiment of the present invention,

FIGS. 6a and 6b are micrographs of a comparison aluminium solder alloy at different magnifications,

FIGS. 7a and 7b are micrographs of a comparison aluminium solder alloy at different magnifications,

FIGS. 8a and 8b are micrographs of an inventive aluminium solder alloy at different magnifications, according to an exemplary embodiment of the present invention,

FIGS. 9a and 9b are micrographs of a comparison aluminium solder alloy at different magnifications,

FIGS. 10a and 10b are micrographs of an inventive aluminium solder alloy at different magnifications, according to an exemplary embodiment of the present invention,

### DETAILED DESCRIPTION OF THE INVENTION

Firstly, a conventionally produced aluminium solder alloy was examined. The contents of the alloying constituents of the sample are specified in Table 1 in percentage by weight or ppm.

As can be seen from Table 1, the conventionally produced comparison alloy L1 has a content of approximately 10% silicon and 11 ppm of boron. The other constituents of the comparison alloy L1 can be found in Table 1.

TABLE 1

| Sample | | Si | Fe | Cu | Mn | Mg | Ti | Cr | Zn | B | P |
|---|---|---|---|---|---|---|---|---|---|---|---|
| L1 | SdT | 10.2 | 0.07 | <0.001 | <0.005 | <0.005 | 50 ppm | <0.001 | 0.005 | 11 ppm | 7 ppm |

The following was carried out with the comparison alloy L1. Firstly, the alloy was conventionally produced based on a standard primary aluminium pig and silicon in foundry quality together with the use of grain refiners in the form of AlTiB bars, so that a typical boron content below 30 ppm was obtained. The melting temperature before the casting was approximately 750° C.

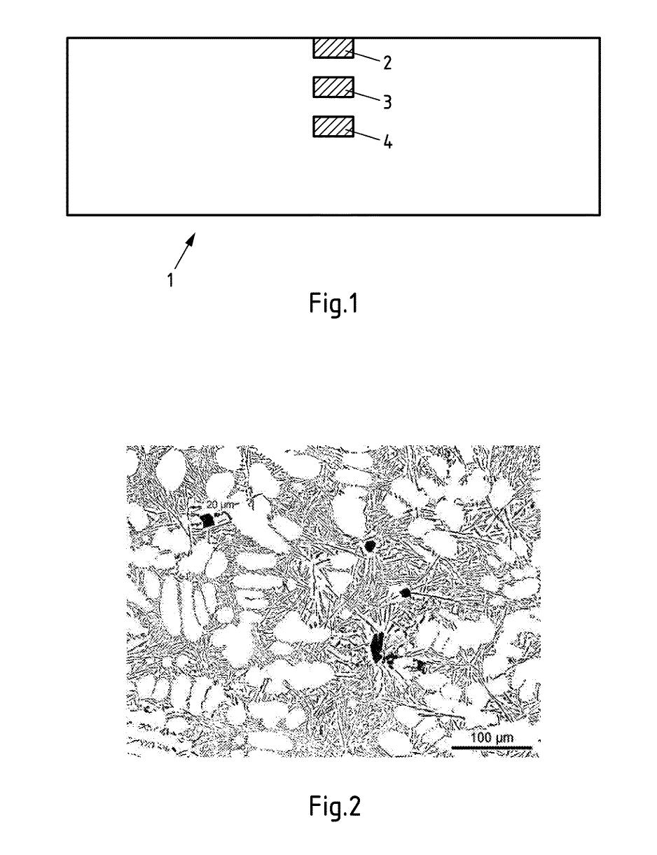

The ingot in the casting format 600 mm×200 mm was cast and milled, i.e. the outer shell, which is up to approximately 20 mm thick, was removed. A slice as illustrated in FIG. 1 was separated from the ingot milled in this way perpendicularly with respect to the casting direction. Area sections of 30 mm×20 mm were examined at three different places, namely in the middle of the ingot on the surface 2, at the height of one quarter of the ingot thickness 3, and in the centre of the ingot 4, for the presence of primary Si particles.

The area sections of 30 mm×20 mm were separated from the ingot slice at the places mentioned and embedded in an epoxy resin, in order to make sample handling easier. The embedded samples were then firstly smoothed manually using SiC paper and abrasive cloth or non-woven abrasive with a grain size of up to 2400. The duration of the smoothing processes was approximately 10 to 20 s with the various grain sizes. Subsequent semi-automatic polishing was carried out firstly with 6 μm and then with 3 μm of polycrystalline diamond suspension for 8 to 9 minutes in each case. Final polishing was carried out using an oxide polishing suspension with a grain size of 0.25 μm for approximately 2 to 5 minutes. The polished sections prepared in this way were evaluated under a reflected-light microscope at 100 times to 200 times magnification.

At the same time, different production parameter studies, for example different holding times, with or without argon gas flushing, and changes to the gas flushing mixture, were carried out with the comparison alloy L1. It was shown that irrespective of the above-mentioned parameters of the melt treatment, coarse primary Si particles were present in the rolled ingots. The results of the number and size of the primary Si particles of comparison alloy L1 are shown in Table 2. An accumulation of the primary Si particles having a size of up to 22 μm could be seen on the surface.

TABLE 2

| | Number of primary Si particles | | | Average size of |
|---|---|---|---|---|
| | | ¼ ingot | Ingot | the primary Si |
| Sample | Surface | thickness | centre | particles (μm) |
| L1 | 53 | 29 | 171 | 12-22 |

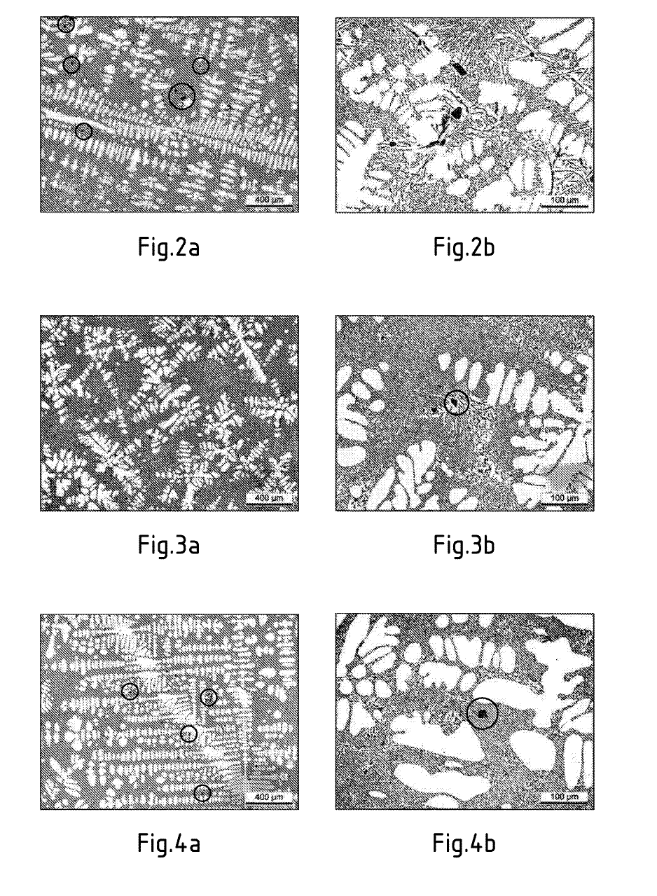

FIG. 2 shows a magnified view of the polished section of an ingot from the ingot centre from comparison alloy L1. In the polished section, it can be clearly identified that coarse primary Si particles are present which have a size of 20 μm and more. The area illustrated in FIG. 2 originates from the centre of the ingot. The magnified image in FIG. 2 has a size of approximately 500 μm×375 μm.

Corresponding tests were carried out on further exemplary embodiments. The composition of the exemplary embodiments is specified in Table 3. The test batches specified in Table 3 were melted in a tiltable, gas-fired crucible melting furnace with a holding capacity of approximately 800 kg. Commercially available aluminium standard pigs of the type with a degree of purity of 99.85 and single-piece silicon for metallurgical applications with a degree of purity of 98 to 99% were used with all test batches. The starting alloys were melted at approximately 800° C. and subsequently skimmed at 750° C. After a holding time of approximately 10 minutes, the melt was also cast into a rolled ingot format of 600 mm×200 mm via a short channel system in a continuous casting line in the vertical continuous casting process (DC casting).

In the case of the test batches, the addition of boron took place after the first skimming at 750 0C by adding an AlBS master alloy. After the master alloy had dissolved in the melt, the melt was again skimmed and cast after 10 minutes' holding time.

The addition of boron took place in several stages. Starting from a standard alloy without the addition of boron, the continuous casting was interrupted, the aluminium boron master alloy type AlBS was added to the alloy, stirred, skimmed and cast after 10 minutes' holding time.

With the addition of boron, it has been found that a part of the boron with the Ti, V and Zr present in the starting melt partly formed borides which deposited in the furnace.

In the case of the test batches, the comparison alloy of test V1 formed the starting alloy for the aluminium alloys according to the invention V2, V3, V4. The comparison alloys V5 and V8 formed the starting alloys for the alloys according to the invention in the tests V6, V7 and V9, respectively. It can be clearly identified in all alloys according to the invention that the proportion of Ti, Zr and V decreases due to the deposition of borides in the furnace.

In Table 3, in addition to details of the proportions of the alloying constituents in wt % (except for boron and Zr), the sum of the alloying constituents Ti, Zr, V and Cr is also specified, as well as the ratio of the content of boron to the sum of the specified alloying constituents.

The ingots produced from the compositions were examined similar to the test L1 with respect to the microstructure of the aluminium alloy and the presence of coarse silicon particles. The results are illustrated in FIGS. 2 to 10 in each case with two polished section views in different magnifications.

TABLE 3

| | | | | | | | | | | | | Σ | B/Σ |
|---|---|---|---|---|---|---|---|---|---|---|---|---|---|
| Test | | | | | | | | B | | Zr | | (Ti, Zr, | (Ti, Zr, |
| No. | | Si | Fe | Cu | Mg | P | Ti | (ppm) | V | (ppm) | Cr | V, Cr) | V, Cr) |
| V1 | Cmp | 10 | 0.107 | 0.0012 | <0.005 | 0.0005 | 0.036 | 3 | 0.0097 | 4 | 0.001 | 0.0471 | 0.01 |
| V2 | Inv | 10 | 0.125 | 0.0012 | <0.005 | 0.0004 | 0.003 | 150 | 0.0011 | 2 | 0.001 | 0.0053 | 2.83 |
| V3 | Cmp | 10.1 | 0.122 | <0.001 | <0.005 | 0.0005 | 0.003 | 70 | 0.0062 | 3 | 0.001 | 0.0105 | 0.67 |
| V4 | Inv | 9.97 | 0.132 | <0.001 | <0.005 | 0.0006 | 0.003 | 270 | 0.001 | 2 | 0.001 | 0.0052 | 5.19 |
| V5 | Cmp | 9.93 | 0.085 | 0.0023 | 0.0013 | 0.0007 | 0.0032 | 6 | 0.0107 | 3 | 0.0006 | 0.0148 | 0.04 |
| V6 | Cmp | 10.06 | 0.085 | 0.0012 | 0.0017 | 0.0006 | 0.0024 | 84 | 0.0079 | 2 | 0.0006 | 0.0111 | 0.76 |
| V7 | Inv | 9.94 | 0.085 | 0.0014 | 0.0007 | 0.0006 | 0.0002 | 355 | 0.0006 | 1 | 0.0004 | 0.0013 | 27.31 |
| V8 | Cmp | 10 | 0.12 | 0.0014 | <0.005 | <0.0005 | 0.0059 | 29 | 0.0087 | 4 | 0.001 | 0.016 | 0.18 |
| V9 | Inv | 10 | 0.22 | 0.0016 | <0.005 | <0.0005 | 0.003 | 690 | 0.0022 | 2 | 0.001 | 0.0064 | 10.78 |

The polished section images of test no. V1 illustrated in FIGS. 2a and 2b come from a reference aluminium alloy which was produced without the addition of AlBS master alloys. The boron content is 3 ppm. The polished section images FIG. 2a and FIG. 2b clearly show that the ingot has numerous primary Si particles with a size of approximately 30 μm and more. The ingot has a coarse AlSi eutectic and shows long unbranched dendrites.

FIGS. 3a and 3b show only a few fine Si primary particles in the polished section images FIG. 3a and FIG. 3b of the aluminium alloy V2 according to the invention. These have a size of less than 10 μm. The AlSi eutectic is clearly formed more finely than in the reference test V1. Boron was added here by using an AlBS master alloy. Two hundred ppm of boron were added to the alloy, so that after holding in the furnace 150 ppm could be measured in the cast sample. The ratio of the boron content to the sum of Ti, Zr, V and Cr contents is 2.83 in the case of test no. V2. The dendrites are formed short and branched. It is assumed that already from a value of 100 ppm the effect of boron on the formation of primary Si particles is sufficient such that their size is at most 20 μm. Aluminium solder alloys having corresponding compositions are particularly well suited for providing very thin aluminium solder layers having good soldering properties and a low proneness to soldering defects.

In contrast to the V2 alloys according to the invention, test no. V3 after the addition of 100 ppm of boron shows a content of 83 ppm of boron in the cast sample. The polished section images of FIGS. 4a and 4b come from an ingot cast with the V3 aluminium alloy. Here and there, primary Si particles having a size above 20 μm can still be identified. The AlSi eutectic is, however, already formed more finely than with the V1 alloy without the addition of boron. The microstructure has long and unbranched dendrites of the primary aluminium phase.

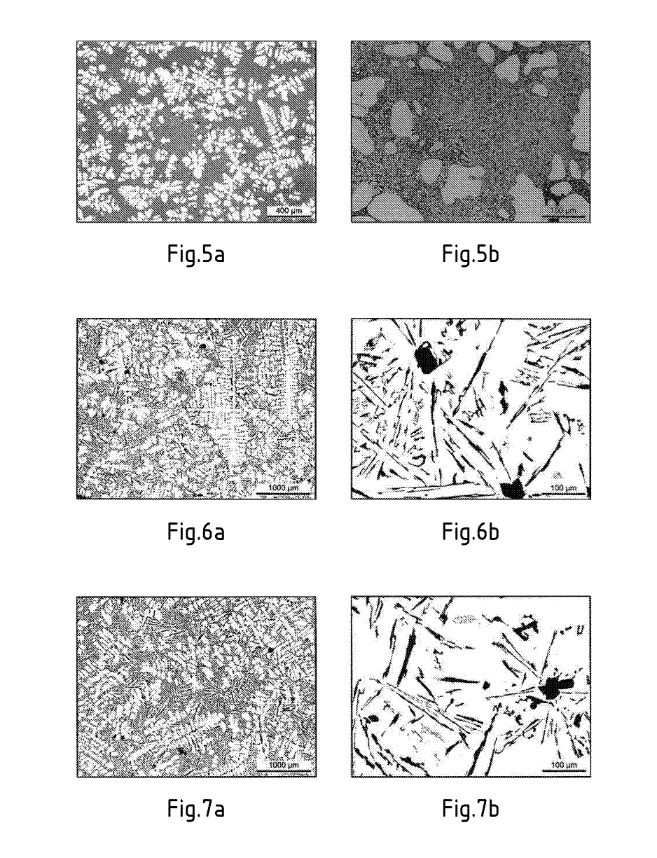

The addition of 300 ppm of boron gave a boron content of 270 ppm in the cast sample in the case of the V4 test alloy. The polished section images of FIGS. 5a and 5b of the V4 test alloy show short branched dendrites and no Si primary particles in contrast to the V3 alloy. In addition, fine agglomerates of AIB particles could be detected (circle in FIG. 5b). The ratio of boron to the sum of the alloying constituents Ti, Zr, V and Cr was 5.19. The aluminium alloy from test V4 showed a very fine microstructure and is therefore very suitable for thin aluminium solder alloys.

In FIGS. 6a and 6b, again the polished section images of a comparison alloy VS are illustrated which has no addition of boron and hence only has a B content of 6 ppm. In the polished section image FIG. 6b, Si primary particles approximately 50 to 60 μm in size can be clearly identified. Furthermore, long dendritic structures in the polished section image can be identified as well as a coarse grain structure.

The AlSi eutectic of test alloy V6 still shows in the polished section images illustrated in FIGS. 7a and 7b long unbranched dendrites and individual Si primary particles having a size of approximately 60 μm. It shows that a boron content of approximately 84 ppm is not sufficient to obtain a significant decrease in the primary particles and a reduction in the number of the particles. At the same time, the effect on the grain refinement is relatively small with a boron content of 84 ppm, so that there is a coarse grain structure.

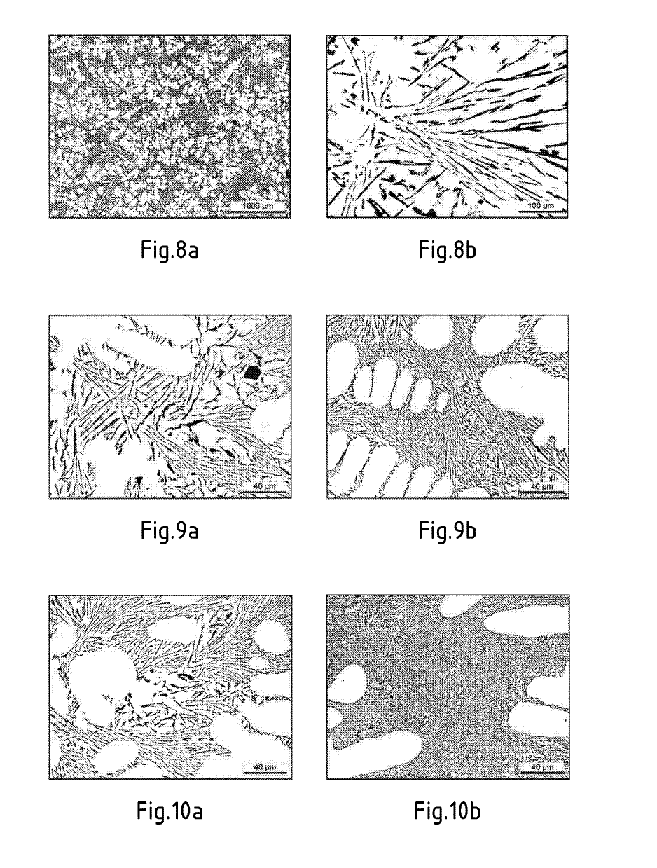

The aluminium alloy V7 of the exemplary embodiment from FIGS. 8a and 8b after the addition of boron has a B content of 355 ppm. The ratio of the boron content to the sum of the contents of Ti, Zr, V and Cr is 27.31 and is particularly big. The AlSi eutectic is, as FIG. 8b shows, lamellar in form and has no Si primary particles. The dendrites of the primary aluminium phase are short and branched, FIG. 8a. The grain size is further reduced compared to lower boron contents. Due to the small grain size and the absence of Si primary particles the aluminium alloy V7 is also well suited for producing aluminium solder products which have a very thin aluminium solder layer.

FIGS. 9a and 9b and FIGS. 10a and 10b show polished section images of the aluminium alloys according to test no. V8 and no. V9. The polished section images are more greatly magnified and show in FIGS. 9a and 10a, respectively, an area with a more coarse formation of the AlSi eutectic and an area with a fine AlSi eutectic in FIG. 9b and FIG. 10b.

FIGS. 9a and 9b show polished section images of a reference alloy V8 to which no boron was added to the alloy. The boron content is 29 ppm. The polished section images clearly show that Si primary particles of 30 μm in size are present in the microstructure. Numerous Si primary particles were detected. The dendrites are very long and indicate grain sizes in the range from 2 to 3 mm. The AlSi eutectic is also coarsely formed.

By contrast, FIGS. 10a and 10b show a clear change in the microstructure due to the addition of boron in the test alloy no. V9. The absence of Si primary particles, the formation of a small grain size and a lamellar formation of the AlSi eutectic are attributed to the boron content of the aluminium alloy of 690 ppm. The primary alpha-aluminium phases can also be identified as branched short dendrites, so that it can be assumed that the aluminium alloy V9 is very suitable for particularly thin aluminium solder alloys. The finer grain structure ensures better formability of an aluminium alloy product coated with a corresponding aluminium solder, while the absence of Si primary particles prevents “burning through” due to the formation of a local AlSi eutectic during the soldering process.

In this exemplary embodiment, the ratio of the boron content to the sum of the contents of Ti, Zr, V and Cr amounts to 10.78. By setting the ratio of the boron content to the sum of the contents of Ti, Zr, V and Cr to at least one times, to at least one and a half times, particularly preferably to at least two and a half times or to at least three times, the reliability of the production process during production of the alloy in relation to the properties presence of Si primary particles is increased, since it can hereby be ensured that the effect of the addition of boron is not disrupted by the formation of borides and their deposition in the furnace. The ratio can preferably rise to values of more than 5, 10 or 20, as the exemplary embodiments show.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An ingot for producing an aluminium alloy product by rolling consisting of an aluminium solder alloy having the following proportions as alloying constituents in percentage by weight:
4.5%≦Si≦12%
and optionally one or more of the following proportions as alloying constituents in percentage by weight:
Ti≦0.2%,
Fe≦0.8%,
Cu≦0.3%,
Mn≦0.10%,
Mg≦2.0%,
Zn≦0.20%,
Cr≦0.05%,
with the remainder aluminium and unavoidable impurities, individually at most 0.05 wt %, in total at most 0.15 wt %, wherein boron is additionally provided as an alloying constituent, wherein boron is added to the alloy such that the boron content is at least 100 ppm and the aluminium alloy is free from primary Si particles having a size of more than 20 μm, in particular 10 μm.

2. The ingot according to claim 1, wherein the aluminium alloy has the following Si content:
6%≦Si≦11%

3. The ingot according to claim 1, wherein the boron content is ≧140 ppm, preferably≧220 ppm, and/or ≦1000 ppm, preferably ≦800 ppm.

4. The ingot according to claim 1, wherein boron is added to the alloy dependent on one or more other alloying constituents.

5. The ingot according to claim 1, wherein boron is added to the alloy dependent on the Ti, Zr and/or V contents, in particular in such a way that the boron content corresponds to at least one times, to one and a half times, to two and a half times or to at least three times the amount of the sum of the Ti, Zr and V and Cr contents.

6. The ingot according to claim 1, wherein the aluminium solder alloy is composed of aluminium alloy type AA 4043, AA 4343, AA 4045, AA 4044 or AA 4104.

7. The ingot according to claim 1, wherein the aluminium solder alloy has a phosphorus content of at most 30 ppm, of at most 20 ppm or of at most 10 ppm.

8. An aluminium alloy product produced from an ingot according to claim 1 by rolling the ingot.

9. The aluminium alloy product according to claim 8, wherein the aluminium alloy product is formed as a cladding sheet or soldering foil.

10. An aluminium alloy product, at least partly consisting of an aluminium solder alloy having the following proportions as alloying constituents in percentage by weight:
4.5%≦Si≦12%
and optionally one or more of the following proportions as alloying constituents in percentage by weight:
Ti≦0.2%,
Fe≦0.8%,
Cu≦0.3%,
Mn≦0.10%,
Mg≦2.0%,
Zn≦0.20%,
Cr≦0.05%,
with the remainder aluminium and unavoidable impurities, individually at most 0.05 wt %, in total at most 0.15 wt %, wherein boron is additionally provided as an alloying constituent, wherein boron is added to the alloy such that the boron content is at least 100 ppm and the aluminium alloy is free from primary Si particles having a size of more than 20 μm, in particular 10 μm, and the aluminium alloy product is a strip and has at least one further layer consisting of aluminium or of another aluminium alloy.

11. The aluminium alloy product according to claim 10, wherein the strip is produced by roll cladding or composite casting.

12. The aluminium alloy product according to claim 10, wherein the aluminium alloy product is formed at least as one part of a soldered component, in particular of a heat exchanger.

13. A method for producing an ingot consisting of an aluminium solder alloy, wherein the ingot is utilizable for producing an aluminium alloy product by rolling, the method comprising the steps of:
melting pure aluminium with unavoidable impurities, individually at most 0.05 wt %, in total at most 0.15 wt %, in a melting furnace, optionally adding one or more of the following proportions
Ti≦0.2%,
Fe≦0.8%,
Cu≦0.3%,
Mn≦0.10%,
Mg≦2.0%,
Zn≦0.20%,
Cr≦0.05%,
to the alloy as further alloying constituents in percentage by weight in the melting furnace or are already at least partially contained in the pure aluminium,
adding silicon to the alloy in the melting furnace until an Si content of 4.5 wt % to 12 wt % of the aluminium alloy has been reached,
adding boron to the alloy such that the boron content is at least 100 ppm and the solidified aluminium alloy is free from primary Si particles having a size of more than 20 μm, in particular 10 μm, and
casting an ingot.

14. The method according to claim 13, wherein the addition of further grain refiners, in particular grain refiners having titanium borides, is dispensed with.

15. The method according to claim 13, wherein the B content is set to 100 ppm, preferably 220 ppm, and/or 1000 ppm, preferably 800 ppm.

16. The method according to claim 13, wherein boron is added to the alloy dependent on the Ti, Zr and/or V contents, in particular in such a way that the B content corresponds to at least one times, to at least one and a half times, to at least two and a half times or to at least three times the amount of the sum of the Ti, Zr and V contents of the starting melt.

17. The method according to claim 13, wherein an aluminium solder alloy is produced from type AA4xxx, AA 4043, AA 4343, AA 4045, AA 4044 or AA 4104.

18. The method according to claim 13, wherein the aluminium solder alloy has a phosphorus content of at most 30 ppm, of at most 20 ppm or of at most 10 ppm.

19. A cladding sheet produced from an ingot according to claim 1, wherein the cladding sheet is sawed from the ingot.
